(19) United States
(12) Patent Application Publication
(10) Pub. No.: US 2024/0314853 A1
(43) Pub. Date: Sep. 19, 2024

(54) CONFIGURING CELLULAR CONNECTIVITY FOR A VEHICLE

(71) Applicant: GM Global Technology Operations LLC, Detroit, MI (US)

(72) Inventors: Hariharan Krishnan, Troy, MI (US); Lakshmi V. Thanayankizil, Troy, MI (US); Mohammad Ishfaq, Northville, MI (US); David M. George, Novi, MI (US); Fan Bai, Ann Arbor, MI (US)

(21) Appl. No.: 18/184,765

(22) Filed: Mar. 16, 2023

(51) Int. Cl. H04W 76/10; H04W 8/20

(52) U.S. Cl. CPC H04W 76/10; H04W 8/20

(57) ABSTRACT

A system for configuring and providing cellular connectivity for a vehicle includes a vehicle communication system and a vehicle controller in electrical communication with the vehicle communication system. The vehicle controller is programmed to establish a connection between the vehicle communication system and a mobile device. The vehicle controller is further programmed to retrieve a cellular connectivity configuration profile from at least one remote server using an internet connection of the mobile device. The vehicle controller is further programmed to configure the vehicle communication system to connect to a cellular network using the cellular connectivity configuration profile.

### INTRODUCTION

The present disclosure relates to systems and methods for providing vehicle connectivity, and more particularly, to systems and methods for configuring and providing cellular connectivity for a vehicle.

To increase occupant convenience and provide entertainment, vehicles may be equipped with telematics systems which allow connection with cellular data networks. Telematics systems in communication with cellular networks may allow an infotainment system of the vehicle to receive and transmit information such as weather information, traffic information, and entertainment information. Furthermore, telematics systems may increase occupant awareness by allowing vehicle systems to communicate with remote vehicles and infrastructure to gather information relevant to the driving situation. However, current telematics may require a cellular data connection to allow for update and configuration of the cellular data plan.

Thus, while current telematics systems and methods achieve their intended purpose, there is a need for a new and improved system and method for configuring and providing cellular connectivity for a vehicle.

### SUMMARY

According to several aspects, a system for configuring and providing cellular connectivity for a vehicle is provided. The system includes a vehicle communication system and a vehicle controller in electrical communication with the vehicle communication system. The vehicle controller is programmed to establish a connection between the vehicle communication system and a mobile device. The vehicle controller is further programmed to retrieve a cellular connectivity configuration profile from at least one remote server using an internet connection of the mobile device. The vehicle controller is further programmed to configure the vehicle communication system to connect to a cellular network using the cellular connectivity configuration profile.

In another aspect of the present disclosure, to retrieve the cellular connectivity configuration profile, the vehicle controller is further programmed to retrieve a cellular connectivity configuration instruction from a first remote server using the vehicle communication system and the internet connection of the mobile device. To retrieve the cellular connectivity configuration profile, the vehicle controller is further programmed to retrieve the cellular connectivity configuration profile from a second remote server using the vehicle communication system and the internet connection of the mobile device. The cellular connectivity configuration profile is retrieved based at least in part on the cellular connectivity configuration instruction.

In another aspect of the present disclosure, the mobile device includes a mobile device communication system and a mobile device controller. The mobile device controller is in electrical communication with the mobile device communication system. The mobile device controller is programmed to generate the cellular connectivity configuration instruction. The mobile device controller is further programmed to transmit the cellular connectivity configuration instruction to the first remote server using the mobile device communication system. The mobile device controller is further programmed to establish the connection between the vehicle communication system and the mobile device using the mobile device communication system.

In another aspect of the present disclosure, the mobile device further includes a mobile device human-interface device (HID) in electrical communication with the mobile device controller. To generate the cellular connectivity configuration instruction, the mobile device controller is further programmed to receive at least one occupant input using the mobile device HID. To generate the cellular connectivity configuration instruction, the mobile device controller is further programmed to generate the cellular connectivity configuration instruction based at least in part on the at least one occupant input.

In another aspect of the present disclosure, the cellular connectivity configuration instruction uniquely identifies the cellular connectivity configuration profile.

In another aspect of the present disclosure, to retrieve the cellular connectivity configuration profile from the second remote server, the vehicle controller is further programmed to establish a connection with the second remote server using the vehicle communication system and the internet connection of the mobile device. To retrieve the cellular connectivity configuration profile from the second remote server, the vehicle controller is further programmed to transmit the cellular connectivity configuration instruction to the second remote server using the vehicle communication system and the internet connection of the mobile device. To retrieve the cellular connectivity configuration profile from the second remote server, the vehicle controller is further programmed to receive the cellular connectivity configuration profile from the second remote server using the vehicle communication system and the internet connection of the mobile device.

In another aspect of the present disclosure, the vehicle controller is further programmed to establish a connection to the at least one remote server using the vehicle communication system. The connection is established using the cellular network based at least in part on the cellular connectivity configuration profile. The vehicle controller is further programmed to transmit a connection confirmation message to the at least one remote server using the connection.

In another aspect of the present disclosure, the connection between the vehicle communication system and the mobile device is a personal area network connection.

In another aspect of the present disclosure, the connection between the vehicle communication system and the mobile device is a wireless local area network connection.

In another aspect of the present disclosure, the cellular connectivity configuration profile is an embedded subscriber identity module (eSIM) profile.

According to several aspects, a method for configuring and providing cellular connectivity for a vehicle is provided. The method includes establishing a connection between a vehicle communication system and a mobile device. The method also includes retrieving a cellular connectivity configuration profile from at least one remote server using an internet connection of the mobile device. The method also includes configuring the vehicle communication system to connect to a cellular network using the cellular connectivity configuration profile.

In another aspect of the present disclosure, retrieving the cellular connectivity configuration profile further may include retrieving a cellular connectivity configuration instruction from a first remote server using the vehicle communication system and the internet connection of the mobile device. Retrieving the cellular connectivity configuration profile further may include retrieving the cellular connectivity configuration profile from a second remote server using the vehicle communication system and the internet connection of the mobile device. The cellular connectivity configuration profile is retrieved based at least in part on the cellular connectivity configuration instruction.

In another aspect of the present disclosure, the method further includes generating the cellular connectivity configuration instruction using the mobile device. The method further includes transmitting the cellular connectivity configuration instruction to the first remote server using the mobile device.

In another aspect of the present disclosure, generating the cellular connectivity configuration instruction using the mobile device further may include receiving at least one occupant input using the mobile device. Generating the cellular connectivity configuration instruction using the mobile device further may include generating the cellular connectivity configuration instruction based at least in part on the at least one occupant input.

In another aspect of the present disclosure, retrieving the cellular connectivity configuration profile from the second remote server further may include establishing a connection with the second remote server using the vehicle communication system and the internet connection of the mobile device. Retrieving the cellular connectivity configuration profile from the second remote server further may include transmitting the cellular connectivity configuration instruction to the second remote server using the vehicle communication system and the internet connection of the mobile device. Retrieving the cellular connectivity configuration profile from the second remote server further may include receiving the cellular connectivity configuration profile from the second remote server using the vehicle communication system and the internet connection of the mobile device.

In another aspect of the present disclosure, the method further includes establishing a connection to the at least one remote server using the vehicle communication system. The connection is established using the cellular network based at least in part on the cellular connectivity configuration profile. The method further includes transmitting a connection confirmation message to the at least one remote server using the connection.

In another aspect of the present disclosure, the cellular connectivity configuration profile is an embedded subscriber identity module (eSIM) profile

According to several aspects, a system for configuring and providing cellular connectivity for a vehicle is provided. The system includes a vehicle communication system and a vehicle controller in electrical communication with the vehicle communication system. The vehicle controller is programmed to establish a connection between the vehicle communication system and a mobile device. The vehicle controller is further programmed to retrieve a cellular connectivity configuration instruction from a first remote server using the vehicle communication system and an internet connection of the mobile device. The vehicle controller is further programmed to retrieve an embedded subscriber identity module (eSIM) profile from a second remote server using the vehicle communication system and the internet connection of the mobile device. The eSIM profile is retrieved based at least in part on the cellular connectivity configuration instruction. The vehicle controller is further programmed to configure the vehicle communication system to connect to a cellular network using the eSIM profile.

In another aspect of the present disclosure, to retrieve the eSIM profile from the second remote server, the vehicle controller is further programmed to establish a connection with the second remote server using the vehicle communication system and the internet connection of the mobile device. To retrieve the eSIM profile from the second remote server, the vehicle controller is further programmed to transmit the cellular connectivity configuration instruction to the second remote server using the vehicle communication system and the internet connection of the mobile device. To retrieve the eSIM profile from the second remote server, the vehicle controller is further programmed to receive the eSIM profile from the second remote server using the vehicle communication system and the internet connection of the mobile device.

In another aspect of the present disclosure, the mobile device includes a mobile device communication system, a mobile device human- interface device (HID), and a mobile device controller. The mobile device controller is in electrical communication with the mobile device communication system and the mobile device HID. The mobile device controller is programmed to receive at least one occupant input using the mobile device HID. The mobile device controller is further programmed to generate the cellular connectivity configuration instruction based at least in part on the at least one occupant input. The mobile device controller is further programmed to transmit the cellular connectivity configuration instruction to the first remote server using the mobile device communication system. The mobile device controller is further programmed to establish the connection between the vehicle communication system and the mobile device using the mobile device communication system.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for configuring and providing cellular connectivity for a vehicle according to an exemplary embodiment; and

FIG. 2 is a flowchart of a method for configuring and providing cellular connectivity for a vehicle according to an exemplary embodiment.

### DETAILED DESCRIPTION

The following description is merely exemplary in nature and is not intended to limit the present disclosure, application, or uses.

Dealers, service providers, and/or end users may desire to reconfigure cellular data connection capabilities of vehicles. For example, if a cellular data plan has expired or been deactivated, end users may want to reactivate the cellular data plan or configure the vehicle to use another cellular data plan. However, configuring cellular data plans may require an internet connection, thus requiring that the vehicle maintain at least one active cellular data plan at all times to allow for reconfiguration as desired. Therefore, the present disclosure provides a new and improved system and method for configuring and providing cellular connectivity for a vehicle.

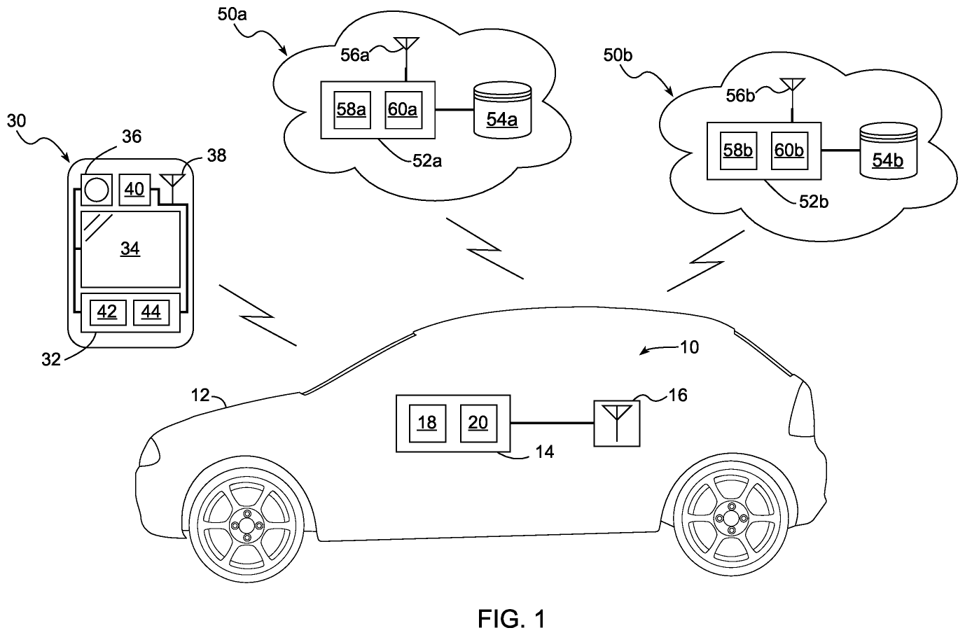

Referring to FIG. 1, a system for configuring and providing cellular connectivity for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a vehicle controller 14 and a vehicle communication system 16 (also referred to as a telematic control unit).

The vehicle controller 14 is used to implement a method 100 for configuring and providing cellular connectivity for a vehicle, as will be described below. The vehicle controller 14 includes at least one processor 18 and a non-transitory computer readable storage device or media 20. The processor 18 may be a custom made or commercially available processor, a central processing unit (CPU), a graphics processing unit (GPU), an auxiliary processor among several processors associated with the vehicle controller 14, a semiconductor-based microprocessor (in the form of a microchip or chip set), a macroprocessor, a combination thereof, or generally a device for executing instructions. The computer readable storage device or media 20 may include volatile and nonvolatile storage in read-only memory (ROM), random-access memory (RAM), and keep-alive memory (KAM), for example. KAM is a persistent or non-volatile memory that may be used to store various operating variables while the processor 18 is powered down. The computer-readable storage device or media 20 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 14 to control various systems of the vehicle 12. The vehicle controller 14 may also consist of multiple controllers which are in electrical communication with each other. The vehicle controller 14 may be inter-connected with additional systems and/or controllers of the vehicle 12, allowing the vehicle controller 14 to access data such as, for example, speed, acceleration, braking, and steering angle of the vehicle 12.

The vehicle controller 14 is in electrical communication with the vehicle communication system 16. In an exemplary embodiment, the electrical communication is established using, for example, a CAN network, a FLEXRAY network, a local area network (e.g., Wi-Fi, ethernet, and the like), a serial peripheral interface (SPI) network, or the like. It should be understood that various additional wired and wireless techniques and communication protocols for communicating with the vehicle controller 14 are within the scope of the present disclosure.

The vehicle communication system 16 is used by the vehicle controller 14 to communicate with other systems external to the vehicle 12. For example, the vehicle communication system 16 includes capabilities for communication with a cellular network using cellular data communication (e.g., using GSMA standards, such as, for example, SGP.02, SGP.22, SGP.32, and the like). The vehicle communication system 16 further includes capabilities for communication with vehicles (“V2V” communication), infrastructure (“V21” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 16 is a wireless communication system configured to communicate via a wireless local area network (WLAN) using IEEE 802.11 standards.

Accordingly, the vehicle communication system 16 may further include an embedded universal integrated circuit card (eUICC) configured to store at least one cellular connectivity configuration profile, for example, an embedded subscriber identity module (eSIM) profile. In the scope of the present disclosure, the cellular connectivity configuration profile is a set of information which allows the vehicle communication system 16 to connect to a cellular network. In a non-limiting example, the cellular connectivity configuration profile includes a unique identifier (e.g., an integrated circuit card identifier), a cellular network code (i.e., a code which identifies the cellular network to which the vehicle communication system 16 may connect), authentication information (i.e., information used to authenticate connections between the vehicle communication system 16 and the cellular network), subscriber information (i.e., information pertaining to the person or entity using the profile, such as name, address, and the like), and/or additional information used for establishing connections between the vehicle communication system 16 and the cellular network.

The vehicle communication system 16 is further configured to communicate via a personal area network (e.g., BLUETOOTH) and/or near-field communication (NFC). However, additional or alternate communication methods, such as mobile telecommunications protocols based on the 3^{rd} Generation Partnership Project (3GPP) standards, are also considered within the scope of the present disclosure. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 16 may include one or more antennas and/or communication transceivers for receiving and/or transmitting data. The vehicle communication system 16 is configured to wirelessly communicate information between the vehicle 12 and another vehicle. Further, the vehicle communication system 16 is configured to wirelessly communicate information between the vehicle 12 and infrastructure or other vehicles. Further, the vehicle communication system 16 is configured to wirelessly communicate information between the vehicle 12 and the cellular network. It should be understood that the vehicle communication system 16 may be integrated with the vehicle controller 14 (e.g., on a same circuit board with the vehicle controller 14 or otherwise a part of the vehicle controller 14) without departing from the scope of the present disclosure.

With continued reference to FIG. 1, a mobile device 30 is in wireless communication with the system 10. While the mobile device 30 is depicted as a smartphone in FIG. 1, it should be understood that additional mobile devices, such as, for example, tablets, fitness trackers, smart wearable devices, and the like are within the scope of the present disclosure.

The mobile device 30 is used to provide information to the occupant when the occupant is not in the vehicle 12. The mobile device 30 includes a mobile device controller 32, a mobile device display 34, a mobile device camera 36, a mobile device communication system 38, and mobile device sensors 40. Each of the mobile device display 34, the mobile device camera 36, the mobile device communication system 38, and the mobile device sensors 40 are in electrical communication with the mobile device controller 32.

The mobile device controller 32 controls the operation of the mobile device 30. The mobile device controller 32 includes at least one mobile device processor 42 and a mobile device non-transitory computer readable storage device or media 44. In a non-limiting example, the mobile device processor 42 and mobile device media 44 of the mobile device controller 32 are similar in structure and/or function to the processor 18 and the media 20 of the vehicle controller 14, as described above.

The mobile device display 34 is used to display information to the occupant. The mobile device display 34 is capable of displaying text, graphics, and/or images. In an exemplary embodiment, the mobile device display 34 is a human-interface device (HID), for example, a touchscreen, capable of receiving inputs from the occupant. It should be understood that the mobile device display 34 may include an LCD display, LED display, and/or the like without departing from the scope of the present disclosure.

The mobile device camera 36 is used to capture images of an environment surrounding the mobile device 30. It should be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The mobile device communication system 38 allows the mobile device controller 32 to communicate with remote systems. In an exemplary embodiment, the mobile device communication system 38 includes a wireless communication system configured to communicate using wireless networks such as a wireless local area network (WLAN) (e.g., using IEEE 802.11 standards) and/or using cellular data communication (e.g., using GSMA standards, such as, for example, SGP.02, SGP.22, SGP.32, and the like). In an exemplary embodiment, the mobile device communication system 38 further includes tethering functionality. Tethering functionality allows the mobile device communication system 38 to “share” an internet connection with another device. In a first exemplary embodiment, tethering involves the mobile device communication system 38 acting as a personal area network (e.g., BLUETOOTH) and sharing a cellular data internet connection of the mobile device 30 with another device. The other device connects to the mobile device communication system 38 via the personal area network and then accesses the internet through the cellular data connection of the mobile device 30. In a second exemplary embodiment, tethering involves configuring the mobile device communication system 38 to act as a Wi-Fi hotspot, allowing the other device to connect to access the internet through the cellular data connection of the mobile device 30. Accordingly, in a non-limiting example, the mobile device communication system 38 includes one or more antennas and/or communication transceivers for transmitting and/or receiving signals.

The mobile device sensors 40 are used to monitor the environment surrounding the mobile device 30. In an exemplary embodiment, the mobile device sensors 40 include motion sensors, such as, for example, an accelerometer, a gyroscope, a magnetometer, and the like. In another exemplary embodiment, the mobile device sensors 40 further include user health sensors, such as, for example, a heart rate sensor, a blood oxygen sensor, a body temperature sensor, and the like.

With continued reference to FIG. 1, a first remote server system is illustrated and generally indicated by reference number 50a. The first remote server system 50a includes a server controller 52a in electrical communication with a server database 54a and a server communication system 56a. In a non-limiting example, the first remote server system 50a is located in a server farm, datacenter, or the like, and connected to the internet. The server controller 52a includes at least one server processor 58a and a server non-transitory computer readable storage device or server media 60a. The description of the type and configuration given above for the vehicle controller 14 also applies to the server controller 52b. In a non-limiting example, the server processor 58a and server media 60a of the server controller 52a are similar in structure and/or function to the processor 18 and the media 20 of the vehicle controller 14, as described above. The server communication system 56a is used to communicate with external systems, such as, for example, the vehicle controller 14 via the vehicle communication system 16. In a non-limiting example, server communication system 56a is similar in structure and/or function to the vehicle communication system 16 of the vehicle 12, as described above.

With continued reference to FIG. 1, a second remote server system is illustrated and generally indicated by reference number 50b. In an exemplary embodiment, the second remote server system 50b is a subscription management data preparation plus (SM-DP+) server, as defined in, for example, GSMA standard SGP.22. In a non-limiting example, the SM-DP+ server is responsible for preparing and storing embedded subscriber identity module (eSIM) profiles, thus enabling over-the-air activation and management of eSIMs. The second remote server system 50b includes a server controller 52b in electrical communication with a server database 54b and a server communication system 56b. In a non-limiting example, the second remote server system 50b is located in a server farm, datacenter, or the like, and connected to the internet. The server controller 52b includes at least one server processor 58b and a server non-transitory computer readable storage device or server media 60b. The description of the type and configuration given above for the vehicle controller 14 also applies to the server controller 52b. In a non-limiting example, the server processor 58b and server media 60b of the server controller 52b are similar in structure and/or function to the processor 18 and the media 20 of the vehicle controller 14, as described above. The server communication system 56b is used to communicate with external systems, such as, for example, the vehicle controller 14 via the vehicle communication system 16. In a non-limiting example, server communication system 56b is similar in structure and/or function to the vehicle communication system 16 of the vehicle 12, as described above.

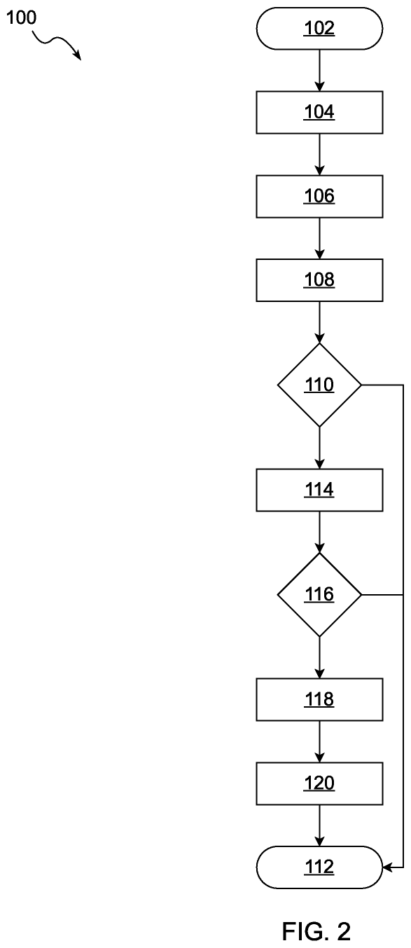

Referring to FIG. 2, a flowchart of the method 100 for configuring and providing cellular connectivity for a vehicle is shown. The method 100 begins at block 102 and proceeds to block 104. At block 104, the mobile device controller 32 generates the cellular connectivity configuration instruction. In the scope of the present disclosure, the cellular connectivity configuration instruction includes information necessary for the vehicle communication system 16 to retrieve a cellular connectivity configuration profile, as will be discussed in greater detail below. In a non-limiting example, the cellular connectivity configuration instruction includes at least one unique identifier (e.g., a vehicle identification number of the vehicle 12), security credentials for retrieving the cellular connectivity configuration profile, and a profile request (including, for example, a cellular network operator, a cellular data plan, and/or the like). In an exemplary embodiment, the occupant uses the mobile device display 34 as a human-interface device to generate the cellular connectivity configuration instruction. In a non-limiting example, the occupant uses a mobile application on the mobile device 30 to select or input the vehicle identification number (VIN) of the vehicle 12 and provide the profile request information corresponding to the cellular connectivity configuration profile desired by the occupant. The cellular connectivity configuration instruction is generated based at least in part on the information provided by the occupant using the mobile device display 34. For example, the occupant may use the mobile application to purchase a cellular data plan. Accordingly, the cellular connectivity configuration instruction is generated based on the cellular data plan purchased by the occupant, such that the cellular data plan may be configured on the vehicle communication system 16, as will be discussed in greater detail below. After block 104, the method 100 proceeds to block 106.

At block 106, the mobile device controller 32 uses the mobile device communication system 38 to transmit the cellular connectivity configuration instruction to the first remote server system 50a. In an exemplary embodiment, the cellular connectivity configuration instruction is received by the server communication system 56a and stored on the server database 54a. After block 106, the method 100 proceeds to block 108.

At block 108, the mobile device 30 instructs the occupant to establish a connection between the vehicle communication system 16 and the mobile device communication system 38. In an exemplary embodiment, the mobile device controller 32 uses the mobile device display 34 to provide instructions to the occupant. In a non-limiting example, the instructions include enabling a BLUETOOTH and/or Wi-Fi function of the vehicle communication system 16 using a human-machine interface (e.g., a touchscreen in electrical communication with the vehicle controller 14) of the vehicle 12. After block 108, the method 100 proceeds to block 110.

At block 110, a connection is established between the vehicle communication system 16 and the mobile device communication system 38. In a first exemplary embodiment, the connection is a personal area network connection (e.g., a BLUETOOTH connection). In a second exemplary embodiment, the connection is a wireless local area network connection (e.g., a Wi-Fi connection). In a third exemplary embodiment, the connection is a wired connection (e.g., using the universal serial bus protocol to connect the mobile device 30 to the vehicle controller 14). In a non-limiting example, the connection between the vehicle communication system 16 and the mobile device communication system 38 is a tethering connection, as discussed above. If the connection is not successfully established, the method 100 proceeds to enter a standby state at block 112. If the connection is successfully established, the method 100 proceeds to block 114.

At block 114, the vehicle controller 14 uses the vehicle communication system 16 to retrieve the cellular connectivity configuration instruction from the first remote server system 50a using an internet connection of the mobile device 30 via the connection with the mobile device 30 established at block 110. In other words, the mobile device 30 acts as a “bridge” between the vehicle communication system 16 and the internet. In an exemplary embodiment, the vehicle controller 14 first transmits the VIN of the vehicle 12 to the first remote server system 50a. The first remote server system 50a then retrieves the cellular connectivity configuration instruction from the server database 54a based at least in part on the VIN of the vehicle 12. The first remote server system 50a then transmits the cellular connectivity configuration instruction to the vehicle communication system 16 via the internet connection of the mobile device 30. After block 114, the method 100 proceeds to block 116.

At block 116, the vehicle controller 14 compares the cellular connectivity configuration instruction received at block 114 to a current cellular connectivity configuration profile of the vehicle communication system 16. In an exemplary embodiment, if the cellular connectivity configuration instruction received at block 114 corresponds to the cellular connectivity configuration profile already stored in the eUICC of the vehicle communication system 16, no update to the cellular connectivity configuration profile is needed, and the method 100 proceeds to enter the standby state at block 112. If the cellular connectivity configuration instruction received at block 114 does not correspond to the cellular connectivity configuration profile already stored in the eUICC of the vehicle communication system 16, or no cellular connectivity configuration profile is stored in the eUICC, an update to the cellular connectivity configuration profile is needed, and the method 100 proceeds to block 118.

At block 118, the vehicle controller 14 uses the vehicle communication system 16 and the internet connection of the mobile device 30 to retrieve the cellular connectivity configuration profile from the second remote server system 50b. In an exemplary embodiment, the second remote server system 50b is the subscription management data preparation plus (SM-DP+) server as discussed above. In a non-limiting example, to retrieve the cellular connectivity configuration profile, the vehicle communication system 16 first establishes a connection with the second remote server system 50b using the internet connection of the mobile device 30. Then, the cellular connectivity configuration instruction retrieved at block 114 is transmitted to the second remote server system 50b. The cellular connectivity configuration instruction is used, for example, to authenticate with the second remote server system 50b (i.e., the SM-DP+server). In an exemplary embodiment, the second remote server system 50b retrieves the cellular connectivity configuration profile from the server database 54b based at least in part on the cellular connectivity configuration instruction. Subsequently, the cellular connectivity configuration profile is transmitted to the vehicle communication system 16 using the server communication system 56b and stored in the eUICC of the vehicle communication system 16. After block 118, the method 100 proceeds to block 120.

At block 120, the vehicle controller 14 configures the vehicle communication system 16 to use the cellular connectivity configuration profile retrieved at block 118 to establish a connection with a cellular network. In an exemplary embodiment, the vehicle controller 14 uses the vehicle communication system 16 to connect to the cellular network and transmit a connection confirmation message to the first remote server system 50a using the cellular network. In a non-limiting example, the connection confirmation message includes information identifying the vehicle 12 (e.g., the VIN of the vehicle 12) and information about the cellular connectivity configuration profile (e.g., the unique identifier, the cellular network code, the authentication information, a phone number of the cellular connectivity configuration profile, cellular network settings, subscriber information, data plan information, and/or the like). After block 120, the method 100 proceeds to enter the standby state at block 112.

In an exemplary embodiment, the vehicle controller 14 repeatedly exits the standby state 112 and restarts the method 100 at block 102. In a non-limiting example, the vehicle controller 14 exits the standby state 112 and restarts the method 100 on a timer, for example, every three hundred milliseconds.

The system 10 and method 100 of the present disclosure offer several advantages. By utilizing the internet connection of the mobile device 30, the cellular connectivity configuration profile of the vehicle communication system 16 may be configured even if the vehicle communication system 16 does not currently have an active cellular connectivity configuration profile, and thus cannot connect to a cellular network to update the profile. Therefore, it is not necessary to maintain an active cellular connectivity configuration profile in the vehicle communication system 16 solely to provide capability to update or change profiles later, conserving resources.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for configuring and providing cellular connectivity for a vehicle, the system comprising:
a vehicle communication system; and
a vehicle controller in electrical communication with the vehicle communication system, wherein the vehicle controller is programmed to:
establish a connection between the vehicle communication system and a mobile device;
retrieve a cellular connectivity configuration profile from at least one remote server using an internet connection of the mobile device; and
configure the vehicle communication system to connect to a cellular network using the cellular connectivity configuration profile.

2. The system of claim 1, wherein to retrieve the cellular connectivity configuration profile, the vehicle controller is further programmed to:
retrieve a cellular connectivity configuration instruction from a first remote server using the vehicle communication system and the internet connection of the mobile device; and
retrieve the cellular connectivity configuration profile from a second remote server using the vehicle communication system and the internet connection of the mobile device, wherein the cellular connectivity configuration profile is retrieved based at least in part on the cellular connectivity configuration instruction.

3. The system of claim 2, wherein the mobile device includes a mobile device communication system and a mobile device controller, wherein the mobile device controller is in electrical communication with the mobile device communication system, and wherein the mobile device controller is programmed to:
generate the cellular connectivity configuration instruction;
transmit the cellular connectivity configuration instruction to the first remote server using the mobile device communication system; and
establish the connection between the vehicle communication system and the mobile device using the mobile device communication system.

4. The system of claim 3, wherein the mobile device further includes a mobile device human-interface device (HID) in electrical communication with the mobile device controller, and wherein to generate the cellular connectivity configuration instruction, the mobile device controller is further programmed to:
receive at least one occupant input using the mobile device HID; and
generate the cellular connectivity configuration instruction based at least in part on the at least one occupant input.

5. The system of claim 2, wherein the cellular connectivity configuration instruction uniquely identifies the cellular connectivity configuration profile.

6. The system of claim 2, wherein to retrieve the cellular connectivity configuration profile from the second remote server, the vehicle controller is further programmed to:
establish a connection with the second remote server using the vehicle communication system and the internet connection of the mobile device;
transmit the cellular connectivity configuration instruction to the second remote server using the vehicle communication system and the internet connection of the mobile device; and
receive the cellular connectivity configuration profile from the second remote server using the vehicle communication system and the internet connection of the mobile device.

7. The system of claim 1, wherein the vehicle controller is further programmed to:
establish a connection to the at least one remote server using the vehicle communication system, wherein the connection is established using the cellular network based at least in part on the cellular connectivity configuration profile; and
transmit a connection confirmation message to the at least one remote server using the connection.

8. The system of claim 1, wherein the connection between the vehicle communication system and the mobile device is a personal area network connection.

9. The system of claim 1, wherein the connection between the vehicle communication system and the mobile device is a wireless local area network connection.

10. The system of claim 1, wherein the cellular connectivity configuration profile is an embedded subscriber identity module (eSIM) profile.

11. A method for configuring and providing cellular connectivity for a vehicle, the method comprising:
establishing a connection between a vehicle communication system and a mobile device;
retrieving a cellular connectivity configuration profile from at least one remote server using an internet connection of the mobile device; and
configuring the vehicle communication system to connect to a cellular network using the cellular connectivity configuration profile.

12. The method of claim 11, wherein retrieving the cellular connectivity configuration profile further comprises:
retrieving a cellular connectivity configuration instruction from a first remote server using the vehicle communication system and the internet connection of the mobile device; and
retrieving the cellular connectivity configuration profile from a second remote server using the vehicle communication system and the internet connection of the mobile device, wherein the cellular connectivity configuration profile is retrieved based at least in part on the cellular connectivity configuration instruction.

13. The method of claim 12, further comprising:
generating the cellular connectivity configuration instruction using the mobile device; and
transmitting the cellular connectivity configuration instruction to the first remote server using the mobile device.

14. The method of claim 13, wherein generating the cellular connectivity configuration instruction using the mobile device further comprises:
receiving at least one occupant input using the mobile device; and
generating the cellular connectivity configuration instruction based at least in part on the at least one occupant input.

15. The method of claim 12, wherein retrieving the cellular connectivity configuration profile from the second remote server further comprises:
establishing a connection with the second remote server using the vehicle communication system and the internet connection of the mobile device;
transmitting the cellular connectivity configuration instruction to the second remote server using the vehicle communication system and the internet connection of the mobile device; and
receiving the cellular connectivity configuration profile from the second remote server using the vehicle communication system and the internet connection of the mobile device.

16. The method of claim 11, further comprising:
establishing a connection to the at least one remote server using the vehicle communication system, wherein the connection is established using the cellular network based at least in part on the cellular connectivity configuration profile; and
transmitting a connection confirmation message to the at least one remote server using the connection.

17. The method of claim 11, wherein the cellular connectivity configuration profile is an embedded subscriber identity module (eSIM) profile.

18. A system for configuring and providing cellular connectivity for a vehicle, the system comprising:
a vehicle communication system; and
a vehicle controller in electrical communication with the vehicle communication system, wherein the vehicle controller is programmed to:
establish a connection between the vehicle communication system and a mobile device;
retrieve a cellular connectivity configuration instruction from a first remote server using the vehicle communication system and an internet connection of the mobile device;
retrieve an embedded subscriber identity module (eSIM) profile from a second remote server using the vehicle communication system and the internet connection of the mobile device, wherein the eSIM profile is retrieved based at least in part on the cellular connectivity configuration instruction; and
configure the vehicle communication system to connect to a cellular network using the eSIM profile.

19. The system of claim 18, wherein to retrieve the eSIM profile from the second remote server, the vehicle controller is further programmed to:
establish a connection with the second remote server using the vehicle communication system and the internet connection of the mobile device;
transmit the cellular connectivity configuration instruction to the second remote server using the vehicle communication system and the internet connection of the mobile device; and
receive the eSIM profile from the second remote server using the vehicle communication system and the internet connection of the mobile device.

20. The system of claim 18, wherein the mobile device includes a mobile device communication system, a mobile device human-interface device (HID), and a mobile device controller, wherein the mobile device controller is in electrical communication with the mobile device communication system and the mobile device HID, and wherein the mobile device controller is programmed to:
receive at least one occupant input using the mobile device HID;
generate the cellular connectivity configuration instruction based at least in part on the at least one occupant input;
transmit the cellular connectivity configuration instruction to the first remote server using the mobile device communication system; and
establish the connection between the vehicle communication system and the mobile device using the mobile device communication system.
